(19) United States
(12) Patent Application Publication
(10) Pub. No.: US 2014/0138984 A1
(43) Pub. Date: May 22, 2014

(54) IMPACT-ABSORBING AUXILIARY MATERIAL FOR VEHICLE

(71) Applicants: DAEHAN SOLUTION CO., LTD, Incheon (KR); IPSUNG CO., LTD., Hwaseong-si (KR)

(72) Inventor: Chung Ho KWON, Seoul (KR)

(73) Assignees: IPSUNG CO., LTD., Hwaseong-si (KR); DAEHAN SOLUTION CO., LTD, Incheon (KR)

(21) Appl. No.: 13/747,709

(22) Filed: Jan. 23, 2013

(30) Foreign Application Priority Data
Nov. 20, 2012 (KR) 10-2012-0131357

(51) Int. Cl. B60R 21/04

(52) U.S. Cl. CPC B60R 21/04
USPC 296/187.05

(57) ABSTRACT

Provided is an impact-absorbing auxiliary material for a vehicle, which is fabricated using pulp containing a biodegradable plastic resin, so that a mold may be easily manufactured without regard to a shape of the auxiliary material, and in particular, which is environmentally friendly so that no waste treatment problems occur in discarding waste and an overall weight thereof is reduced. In particular, provided is an impact-absorbing auxiliary material for a vehicle, which is capable of obtaining sufficient impact-absorbing performance required in the impact-absorbing auxiliary material through successive deformation of ridges and ribs by connecting ribs between hollow ridge portions and forming integrally. The auxiliary material includes a base fabricated using pulp containing biodegradable plastic, wherein hollow ridges integrally protrude from the base in a plurality of rows at predetermined intervals, the ridges adjacent to each other are connected to each other through ribs, and the pulp and the biodegradable plastic are mixed in a weight ratio of about 50:1 to 70:1.

### CROSS-REFERENCE TO RELATED APPLICATION

This application claims priority to and the benefit of Korean Patent Application No. 10-2012-0131357, filed on Nov. 20, 2012, the disclosure of which is incorporated herein by reference in its entirety.

### BACKGROUND

1. Field of the Invention

The present invention relates to an impact-absorbing auxiliary material for a vehicle, and more particularly, to an impact-absorbing auxiliary material, which is fabricated using pulp containing biodegradable plastic, so as to improve an impact-absorbing performance to be superior to that of an auxiliary material fabricated only using pulp, and in particular, so as to be more environmentally friendly while improving gas mileage due to a reduced weight.

2. Discussion of Related Art

In general, vehicles exported to the United States of America have to satisfy a regulation (FMVSS 201U) of installing indoor impact-absorbing structures for protecting passengers such as a driver when the vehicles are impacted from the outside. According to the above regulation, when designing built-in (interior) components of a vehicle, a method of designing an impact-absorbing structure for satisfying FMH impact performance is necessary.

FIG. 1 shows an auxiliary impact-absorbing material 10 that is mounted between a roof panel boundary and a head lining of a vehicle to protect heads of passengers including a driver, according to the above regulation. In FIG. 1, the auxiliary impact-absorbing material 10 is formed by arranging a plurality of ribs 11 that are formed as band segments of plate shape at predetermined intervals, and forming sub-ribs 12 between the plurality of ribs 11 integrally at predetermined intervals.

In particular, the auxiliary impact-absorbing material 10 is fabricated using a synthetic resin so as to be deformed and crushed when body parts (example, head) of a passenger collide with the auxiliary impact-absorbing material 10 due to impact applied to the vehicle, thereby obtaining an impact-absorbing effect.

However, the above impact-absorbing auxiliary material in the related art has the following problems. First, because the impact-absorbing auxiliary material is formed of a resin material, residues that are classified as industrial waste are generated during fabrication processes of the impact-absorbing auxiliary material. Also, produced goods are also classified as industrial waste when being discarded, and thus discard costs increase and environmental pollution may occur. Second, the impact-absorbing auxiliary material in the related art absorbs the impact using a structural characteristic thereof, and to do this, the impact-absorbing auxiliary material has to be formed as an integral type. Thus, the impact-absorbing auxiliary material is manufactured using a mold. However, the impact-absorbing auxiliary material has a complicated structure, and thus it is difficult to manufacture the mold, thereby increasing fabrication costs compared to other impact-absorbing auxiliary material.

Thus, the present applicant filed a Korean patent application about an impact-absorbing auxiliary material fabricated using pulp on Korean Intellectual Property Office (Korean Patent application No. 10-2012-0121851). However, although the impact-absorbing auxiliary material fabricated using pulp has superior impact-absorbing performance to that of an impact-absorbing auxiliary material formed of a resin material, a weight of the impact-absorbing auxiliary material per unit area is slightly higher than that of the impact-absorbing auxiliary material in the related art, and thus there is an additional need to reduce the weight.

### SUMMARY OF THE INVENTION

The present invention is directed to an impact-absorbing auxiliary material for a vehicle, which is fabricated using pulp containing a biodegradable plastic resin, so that a mold may be easily manufactured without regard to a shape of the auxiliary material, and in particular, which is environmentally friendly so that no waste treatment problems occur in discarding waste, and an overall weight thereof is reduced.

The present invention is also directed to an impact-absorbing auxiliary material of a vehicle, which is capable of obtaining sufficient impact-absorbing performance required in the impact-absorbing auxiliary material through successive deformation of ridges and ribs by connecting ribs between hollow ridge portions and forming integrally.

According to an aspect of the present invention, there is provided an impact-absorbing auxiliary material including a base fabricated using pulp containing biodegradable plastic, wherein hollow ridges integrally protrude from the base in a plurality of rows at predetermined intervals, the ridges adjacent to each other are connected to each other through ribs, and the pulp and the biodegradable plastic are mixed in a weight ratio of about 50:1 to about 70:1.

Each of the ridges may be configured to form a triangle or an equilateral triangle with other adjacent ridges. Each of the ridges may be formed as a hexagonal cone shape, and may have a maximum inner diameter of about 15 to 20 mm.

The ridges and the ribs may be configured to protrude to a height of about 5 to 15 mm.

Each of the ribs may have a length of about 15 to 30 mm.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of a configuration of an impact-absorbing auxiliary material in the related art;

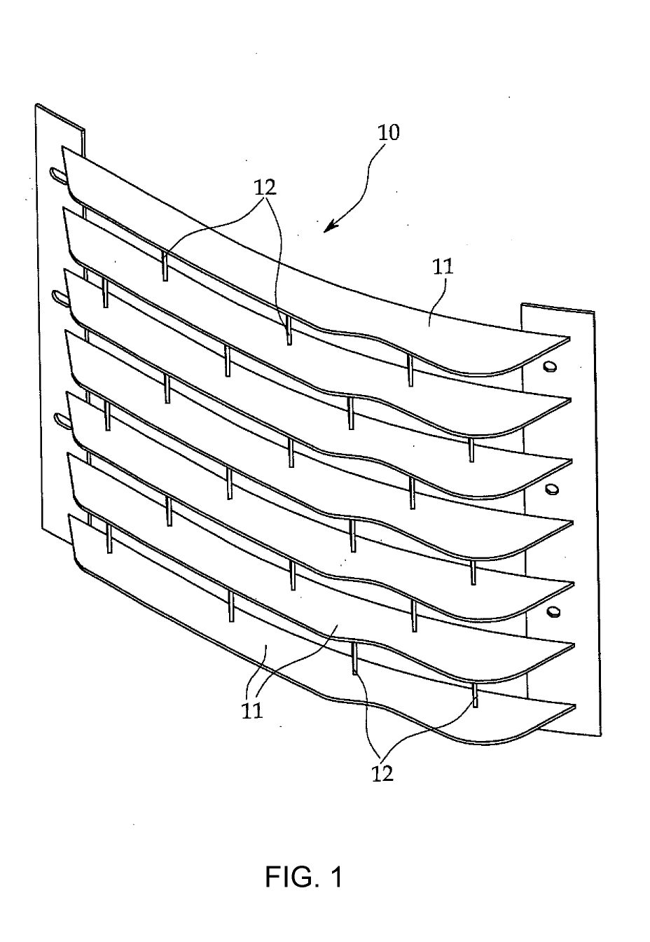

FIG. 2 is a perspective view of an impact-absorbing auxiliary material according to an embodiment of the present invention;

FIG. 3 is a cross-sectional view of the configuration of the impact-absorbing auxiliary material according to the embodiment of the present invention taken along line A-A of FIG. 2;

FIG. 4 is a plan view of the configuration of the impact-absorbing auxiliary material according to the embodiment of the present invention;

FIG. 5 is a graph showing an acceleration value of an impact-absorbing auxiliary material according to a content of a biodegradable plastic in accordance with the embodiment of the present invention;

FIG. 6 is photographs of the impact-absorbing auxiliary material before and after an impact test illustrating a result of the impact test according to the embodiment of the present invention;

FIG. 7 is a graph showing a result of an impact test of the impact-absorbing auxiliary material according to the embodiment of the present invention; and

FIG. 8 is a graph showing a result of comparing areal densities of the impact-absorbing auxiliary material, according to the embodiment of the present invention.

### DETAILED DESCRIPTION OF EXEMPLARY EMBODIMENTS

Exemplary embodiments of the present invention will be described in detail below with reference to the accompanying drawings. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although a few embodiments of the present invention will be shown and described, it would be appreciated by those skilled in the art that changes may be made in these exemplary embodiments without departing from the principles and spirit of the invention, the scope of which is defined in the claims and their equivalents.

(Configuration)

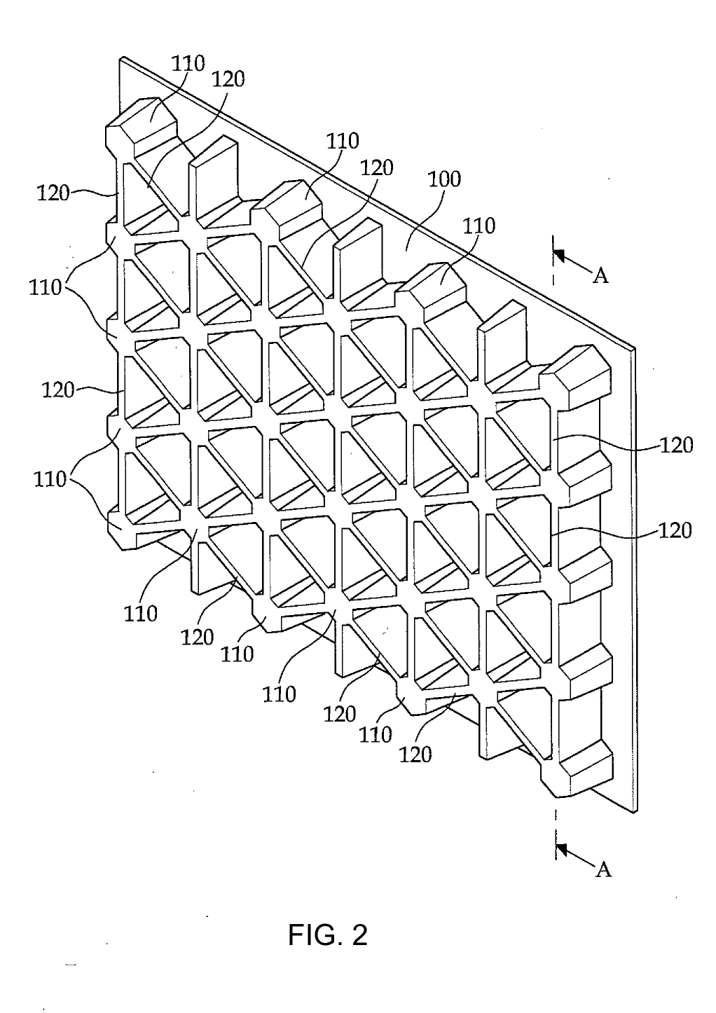

Referring to FIGS. 2 through 6, an impact-absorbing auxiliary material according to an embodiment of the present invention is configured to include a base 100 formed as a plate shape using pulp containing biodegradable plastic, hollow ridges 110 formed integrally with the base 100 in a plurality of rows, and ribs 120 connecting the ridges 110 to each other. Thus, sufficient impact-absorbing performance may be obtained through successive deformation of the ridges 110 and the ribs 120. Moreover, since the ridges 110 and the ribs 120 are fabricated using pulp, like the base 100, so as to be recyclable, and in particular, by containing a biodegradable plastic, an entire weight of the impact-absorbing auxiliary material may be reduced and gas mileage of a vehicle may be improved.

Hereinafter, the above configuration will be described in more detail.

The impact-absorbing auxiliary material according to an embodiment of the present invention is fabricated using pulp containing the biodegradable plastic, thereby being recyclable. The impact-absorbing auxiliary material includes the base 100 of a plate shape having a predetermined size.

In the embodiment of the present invention, the pulp and the biodegradable plastic are mixed with each other in a weight ratio of about 50:1 to about 70:1. At the above weight ratio level, the biodegradable plastic may reduce the entire weight of the impact-absorbing auxiliary material without affecting the impact-absorbing performance required as the impact-absorbing auxiliary material.

Here, the biodegradable plastic is a plastic material (a high molecular compound and mixtures thereof) that is decomposed to a low molecular compound by microorganisms in nature.

Any kind of biodegradable plastic may be used, provided that the objective of the invention, that is, weight loss, may be satisfied. Here, poly-hydroxy butylic acid (PHB) using a high molecular compound biosynthesis function of microorganisms and derivatives thereof, starch molds obtained from natural high molecular compounds that are made from natural plants or animals, poly lactic acid (PLA) and polycaprolactone (PCL) that is an aliphatic polyester made by chemically synthesizing high molecular compounds that are easily biodegradable, and complex starch/PCL conjugates and PHB/PCL conjugates having improved functions using materials or combination methods of the above described biodegradable plastic may be used, for example.

In the embodiment of the present invention, poly lactic acid (PLA) that has similar physical properties to conventional polyethylene (PE) and can be mass produced may be used as the biodegradable plastic. In particular, PLA is decomposed in water to be low molecular, and then decomposed by microorganisms, and thus, the impact-absorbing performance the weight loss effect required by the present invention can be obtained using the PLA. The impact-absorbing performance and the weight loss effect will be described below with reference to impact tests.

In particular, the ridges 110 integrally protrude from the base 100 in a plurality of rows. Here, each of the ridges 110 may be formed to be hollow to obtain an impact-absorbing effect when it is deformed due to the impact.

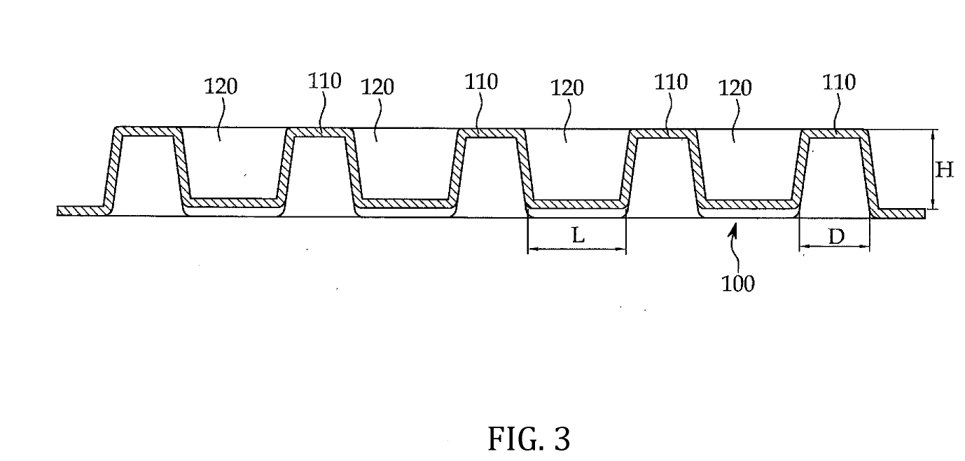

Also, each of the ridges 110 may be integrally formed with the base 100 so as to configure a triangle shape, in particular, an equilateral triangle shape, with other adjacent ridges 110. Thus, hexagonal shapes are configured with the ribs 120 formed between the ridges 110, as shown in FIG. 3, in order to increase structural rigidity.

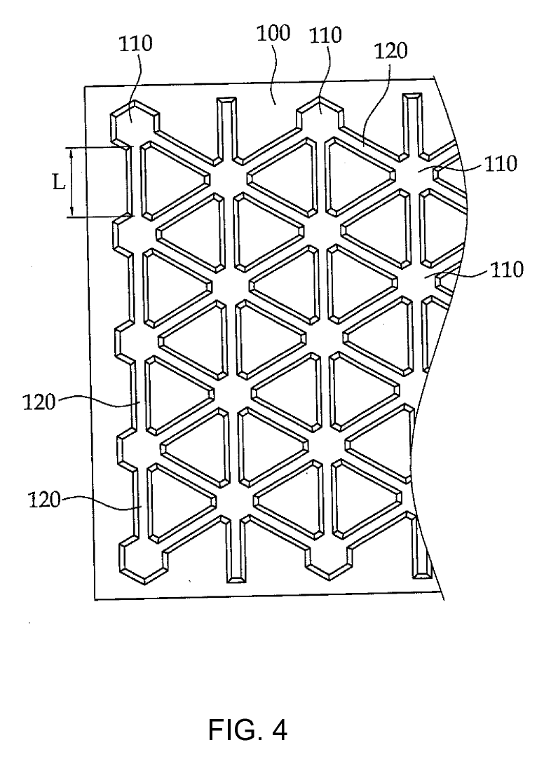

In addition, each of the ridges 110 may be formed as a circular cylinder shape for ensuring rigidity; however, each of the ridges 110 may be preferably formed as a hexagonal cone shape to be deformed easier than the circular cylinder shape. As shown in FIGS. 3 and 4, the above ridge 110 may be formed to have a protruding height H of about 5 to 15 mm from the base 100 and a maximum inner diameter D of about 15 to 20 mm in consideration of an interval between a roof panel and a head lining of a vehicle.

Meanwhile, the ribs 120 are formed between the ridges 110. Each of the ribs 120 is formed to have a height that is the same as that of the ridge 110 and a length L of about 15 to 30 mm. Such ribs 120 are formed integrally on the base 100 with the ridges 110 so as to support the ridges 110 between the ridges 110.

(Impact Performance Test)

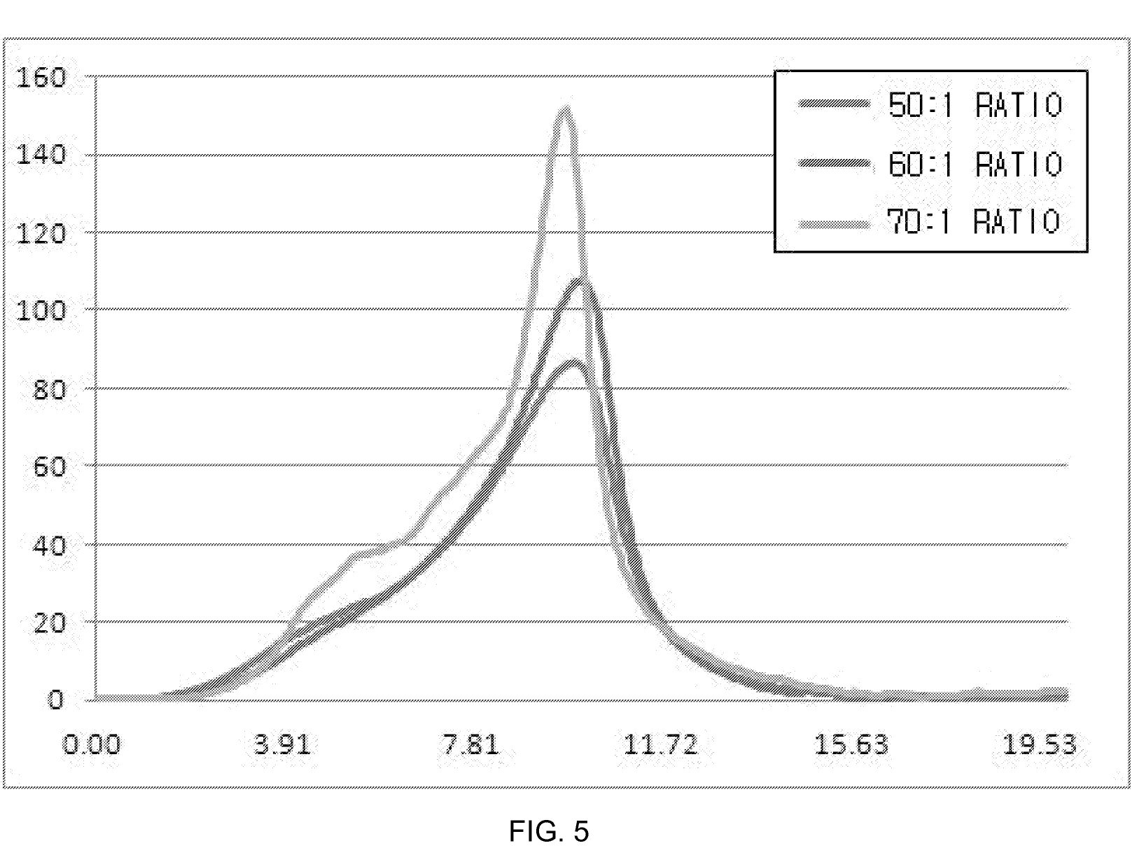

Impact performance tests of the impact-absorbing auxiliary material formed of the pulp containing the biodegradable plastic and an impact-absorbing auxiliary material formed using pulp only were performed, and results are shown as follows (refer to FIGS. 5 through 8).

First, a variation of an acceleration value according to a change of the biodegradable plastic content will be described below under test conditions shown in the following Table 1, before performing the impact performance test of comparative examples.

In Table 1, three specimens were fabricated while varying contents of the pulp and the biodegradable plastic. In addition, free-fall of a sphere on which the triaxial accelerometer was installed was performed from a height of 0.7 M, and then a variation in acceleration occurring when the sphere impacted each of the specimens was compared with others.

TABLE 1

| Classification | Ratio of 50:1 | Ratio of 60:1 | Ratio of 70:1 |
|---|---|---|---|
| Height | 0.7 M | 0.7 M | 0.7 M |
| Weight | 24.5 g | 25 g | 26.5 g |

| | |
|---|---|
| Biodegradable | PLA |
| plastic | |

1) Height: Free-fall height of the sphere
2) The ratio denotes a weight ratio between the pulp and the biodegradable plastic.
3) The weight is a weight per unit area, and when the auxiliary material was fabricated only using pulp, the weight is 34.0 g.

As shown in Table 1, when free-fall of the sphere on which the triaxial accelerometer was mounted was performed from a height of 0.7 M to impact each of the specimens, accelerometer values according to time variation as shown in FIG. 5 were obtained. In FIG. 5, the accelerometer value is reduced as the content of the biodegradable plastic is relatively reduced. Accordingly, when the biodegradable plastic is contained in the pulp at the weight ratio of about 50:1 that is the smallest ratio, the impact-absorbing performance is the highest.

Also, the impact-absorbing auxiliary material having the above weight ratio of about 50:1 has excellent impact-absorbing performance as shown in FIG. 5, and moreover, has a lighter weight per unit area than any other examples of different weight ratios as shown in the following Table 2. That is, when compared with the impact-absorbing auxiliary material fabricated only using pulp and having the weight of 34.0 g, it may be expected that the impact-absorbing auxiliary material having the above weight ratio is 24.5 g, that is, a weight loss of about 27.9% can be obtained ((34.0−24.5)/34.0=0.279 . . . ).

As shown in Table 1 and FIG. 5, the more biodegradable plastic is contained in the pulp, the less the weight is; however, the impact-absorbing performance may become lower than the impact-absorbing performance level required by the impact-absorbing auxiliary material. Therefore, the weight ratio of the pulp and the biodegradable plastic may be preferably defined to be within a range from about 50:1 to about 70:1 for obtaining the appropriate impact-absorbing performance.

On the other hand, test conditions for comparing the impact-absorbing auxiliary material fabricated using pulp containing the biodegradable plastic according to the embodiment of the present invention with other impact-absorbing auxiliary materials fabricated only using pulp, are shown in following Table 2.

TABLE 2

| | | Compar- | Compar- | | |
|---|---|---|---|---|---|
| | | ative | ative | Embodi- | Embodi- |
| Classification | | example 1 | example 2 | ment 1 | ment 2 |
| Test | Height | 0.7 M | 0.7 M | 0.7 M | 0.7 M |
| condi- | Height | 15 mm | 15 mm | 15 mm | 15 mm |
| tions | of | | | | |
| | thread | | | | |
| | Area | 18.1 × | 18.2 × | 18.3 × | 18.2 × |
| | | 12.2 (cm²) | 12.2 (cm²) | 12.0 (cm²) | 12.0 (cm²) |

1) Height: free fall height of sphere
2) Area denotes an area of the base
3) Comparative examples 1 and 2 are two specimens fabricated only using pulp.
4) Embodiments 1 and 2 are two specimens in which the pulp and the biodegradable plastic are mixed by a weight ratio of about 50:1.

The impact performance test was performed using a triaxial accelerometer, a sphere on which the triaxial accelerometer was mounted was dropped from a height of 0.7 M to impact each of the specimens, and a variation of the acceleration and area densities caused when the sphere impacted the specimens was measured as follows.

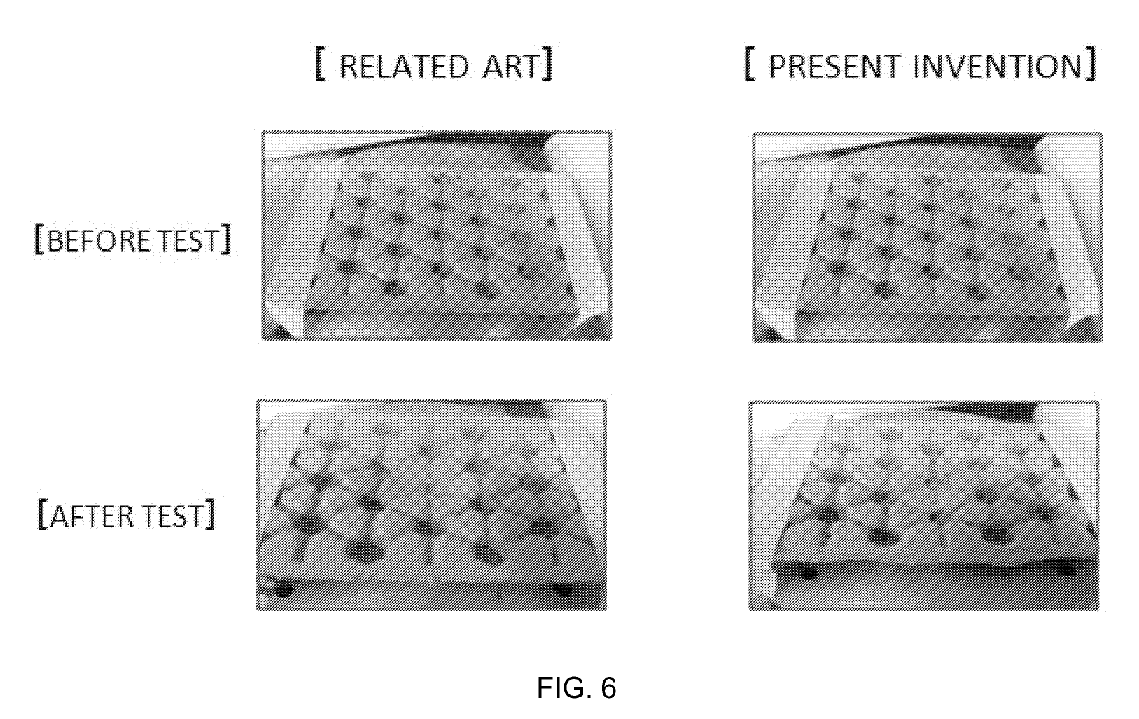

FIG. 6 shows states of the embodiment 1 which was fabricated using pulp containing the biodegradable plastic and Comparative example fabricated only using pulp after performing the accelerometer tests. As shown in FIG. 6, when the embodiments and Comparative examples are substantially compared, respective changes of the impact-absorbing auxiliary materials according to the test were similar.

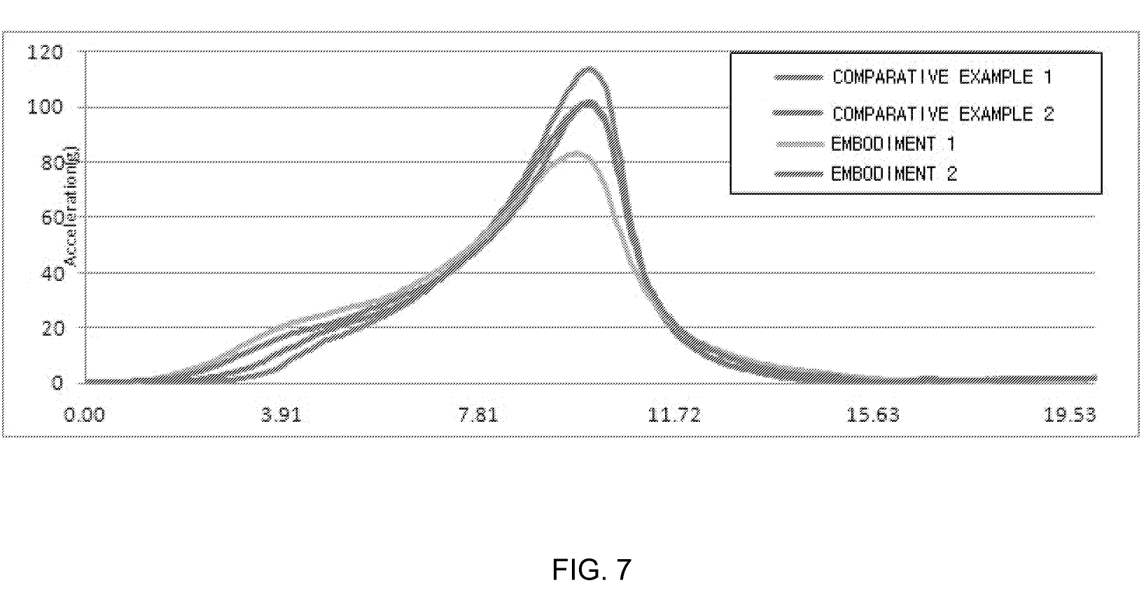

FIG. 7 is a graph showing a variation of the acceleration according to time. As shown in FIG. 7, it may be found that Comparative example 1 and Comparative example 2 have slightly higher acceleration values than the embodiments 1 and 2, and the embodiment 1 has the highest impact-absorbing performance.

Maximum acceleration values of Comparative examples and the embodiments shown in FIG. 7 can be compared as shown in the following Table 3. In Table 3, the maximum acceleration value of the embodiment 2 is 101.78 m/s², which is similar to that of Comparative example, that is, 101.17 m/s². In addition, it may be found that the maximum acceleration value of the embodiment 1 is 83.06 m/s² which is greatly improved compared to Comparative examples 1 and 2.

TABLE 3

| | | Maximum |
|---|---|---|
| | Weight | acceleration |
| Classification | (kg/m²) | value (m/s²) |
| Comparative | 1.539 | 113.88 |
| example 1 | | |
| Comparative | 1.531 | 101.17 |
| example 2 | | |
| Embodiment 1 | 1.138 | 83.06 |
| Embodiment 2 | 1.121 | 101.78 |

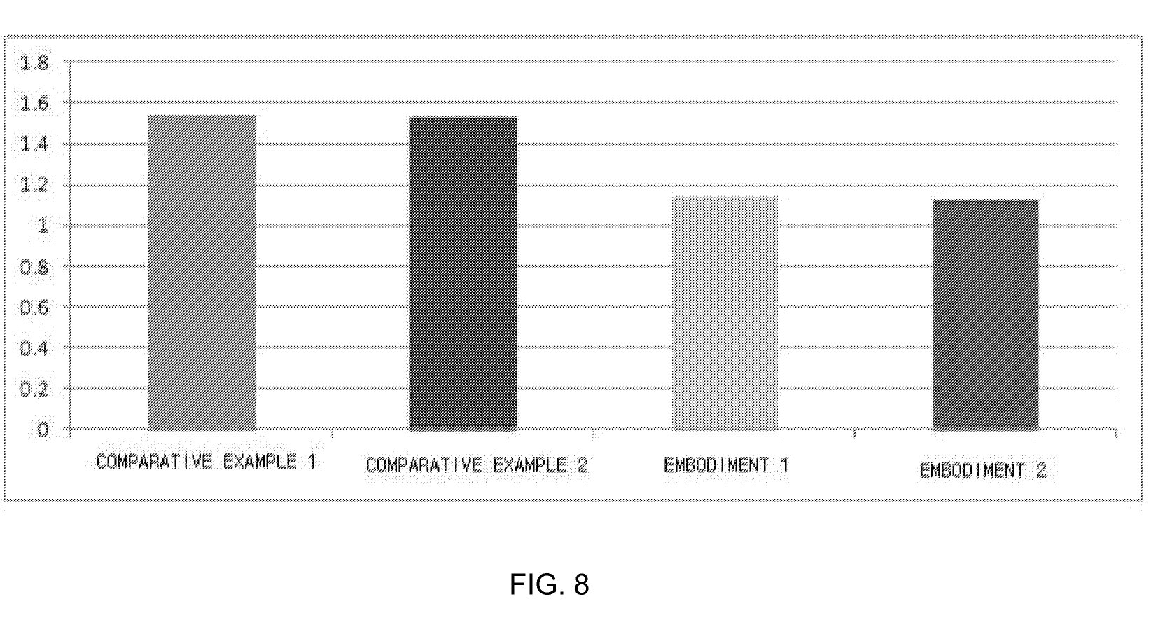

FIG. 8 is a graph showing areal densities, and maximum values are shown in the above Table 3. In Table 3, Comparative example 1 has a weight of 1.539 kg/m², and the embodiment 1 has a weight of 1.138 kg/m². Accordingly, the entire weight of the embodiment 1 is reduced by about 26% ((1.539-1.138)/1.539=0.26). In addition, it may be found that Comparative example 2 has a weight of 1.531 kg/m² and the embodiment 2 has a weight of 1.121 kg/m², and accordingly, the entire weight of the embodiment 2 is reduced by about 26% ((1.531-1.121)/1.531=0.267).

As described above, when comparing the embodiments of the present invention with Comparative examples, it may be confirmed that the auxiliary material absorbing impact fabricated using pulp containing the biodegradable plastic has a weight reduced by about 26% while maintaining the impact-absorbing performance at the same level or higher than that of the impact-absorbing auxiliary material fabricated only using pulp.

Therefore, it may be expected that the impact-absorbing auxiliary material fabricated using the pulp containing the biodegradable plastic according to the present invention has the impact-absorbing performance of the same level or higher and has the entire weight that is much less than those of the impact-absorbing auxiliary material in the related art, which is fabricated only using pulp. Thus, when the impact-absorbing auxiliary material according to the present invention is actually applied to a vehicle, the gas mileage may be improved.

Also, since the biodegradable plastic can be easily decomposed when buried in the ground with the pulp, the impact-absorbing auxiliary material according to the present invention is environmental friendly.

The impact-absorbing auxiliary material according to the present invention has the following effects.

(1) Since the impact-absorbing auxiliary material according to the present invention has a reduced weight, the gas mileage of the vehicle may be improved due to the weight reduction when applied to the vehicle. (Weight reduction effect by about 25% compared to the impact-absorbing auxiliary material in the related art fabricated using pulp.)

(2) Since the biodegradable plastic has a characteristic to be decomposed by microorganisms such as bacteria, algae, or fungi, which is present in nature when it is buried in the ground or in the sea, and thus the impact-absorbing auxiliary material according to the present invention is environmentally friendly.

(3) The impact-absorbing auxiliary material fabricated using pulp containing the biodegradable plastic improves the maximum acceleration value of the impact-absorbing performance, compared to the impact-absorbing auxiliary material fabricated only using pulp.

(4) Since the impact-absorbing auxiliary material is fabricated using pulp containing the biodegradable plastic, it has excellent formability. Thus, if the impact-absorbing auxiliary material has a complicated shape in accordance with the shape thereof, it may be easily fabricated.

(5) Since the pulp and the biodegradable plastic that are environmentally friendly are used as raw materials, there is no a waste treatment problem and there is no possibility of causing environmental pollution.

(6) Since it is easier to fabricate the mold using pulp in a mold fabrication than the plastic mold in the related art, initial investment costs may be reduced.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An impact-absorbing auxiliary material of a vehicle, the auxiliary material comprising a base fabricated using pulp containing biodegradable plastic, wherein hollow ridges integrally protrude from the base in a plurality of rows at predetermined intervals, the ridges adjacent to each other are connected to each other through ribs, and the pulp and the biodegradable plastic are mixed in a weight ratio of about 50:1 to about 70:1.

2. The impact-absorbing auxiliary material of claim 1, wherein each of the ridges is configured to form a triangle or an equilateral triangle with other adjacent ridges.

3. The impact-absorbing auxiliary material of claim 2, wherein each of the ridges is formed as a hexagonal cone shape.

4. The impact-absorbing auxiliary material of claim 3, wherein each of the ridges has a maximum inner diameter of about 15 to 20 mm.

5. The impact-absorbing auxiliary material according to any one of claims 1 through 4, wherein the ridges and the ribs are configured to protrude to a height of about 5 to 15 mm.

6. The impact-absorbing auxiliary material of claim 5, wherein each of the ribs has a length of about 15 to 30 mm.
